(19) United States
(12) Patent Application Publication
(10) Pub. No.: US 2009/0074388 A1
(43) Pub. Date: Mar. 19, 2009

(54) Recording apparatus and recording method for dual-layer recording disk

(75) Inventors: Shigeru Hashimoto, Saitama (JP); Takashi Hora, Saitama (JP)

Correspondence Address: YOUNG & THOMPSON, 209 Madison Street, Suite 500, ALEXANDRIA, VA, 22314, US

(73) Assignee: Pioneer Corporation, Tokyo (JP)

(21) Appl. No.: 11/918,868

(22) PCT Filed: Apr. 19, 2006
(86) PCT No.: PCT/JP2006/308191

§ 371 Date: Oct. 19, 2007

(30) Foreign Application Priority Data
Apr. 19, 2005 (JP) 2005-121734

(51) Int. Cl. H04N 5/00

(52) U.S. Cl. 386/126; 386/E05.064

(57) ABSTRACT

At the time of recording contents data in real time over a first layer and a second layer of a double layer recordable DVD, a first VTS is formed by contents data recorded in a first layer recording area (43) and a second VTS is formed by contents data recorded in a second layer recording area (46). In an area (55) composed of a remaining area (53) of the first layer recording area (43) and a head area (54) of the second layer recording area (46), backup information of VTSI of the first VTS and VTSI of a second VTS are recorded.

### TECHNICAL FIELD

The present invention relates to a recording apparatus and a recording method which allow content data to be recorded onto a dual-layer recording disk, i.e. an optical disk having two recording layers.

### BACKGROUND ART

DVDs are widely spread as optical disks which can record information at high density. The DVDs include a read-only type DVD, a write-once type DVD, and a rewritable type DVD. The read-only type DVD includes a DVD having one layer with information recorded, or a DVD having two layers with information recorded. Moreover, the dual-layer type DVD includes a single-sided dual-layer type and a double-sided dual-layer type.

Currently, a single-layer write-once type DVD is widely spread. The single-layer write-once type DVD has a recording capacity of 4.7 GB. On the single-layer write-once type DVD, content data including, e.g., about two-hour video images and audio in substantially the same quality as in a commercially-available read-only type DVD can be recorded in real time. For example, the content data including video images and audio, which are filmed and recorded by a video camera apparatus or the like, can be received. Substantially at the same time, the received content data can be encoded. Moreover, substantially at the same time, the encoded content data can be continuously recorded onto the write-once type DVD.

### DISCLOSURE OF INVENTION

### Subject to be Solved by the Invention

By the way, lately, the single-sided dual-layer write-once type DVD (hereinafter referred to as a “dual-layer write-once type DVD”) has been developed. The dual-layer write-once type DVD has a larger recording capacity than that of the single-layer write-once type DVD. The dual-layer write-once type DVD is expected to realize the real-time recording of the content data, which is longer than the content data that can be recorded onto the single-layer write-once type DVD.

However, there are the following problems in order to realize the real-time recording of such long content data.

Firstly, it is hard to record the content data in real time over the first layer and the second layer of the dual-layer write-once type DVD in compliance with a DVD video standard.

That is, if the content data is continuously recorded onto the dual-layer write-once type DVD, the content data is sometimes recorded over the first layer and the second layer, depending on the recording state of the dual-layer write-once type DVD. By the way, in the DVD video standard, a unit of cell exists as one of recording management information. Normally, the content data is encoded in compliance with a MPEG standard and is recorded onto the dual-layer write-once type DVD with information about the cell, which is management information on the DVD video standard. The DVD video standard defines that one cell is disposed in the same layer. Thus, if the content data is simply continuously recorded onto the dual-layer write-once type DVD, in some cases, the cell is recorded over the layers. The DVD on which the cell is recorded over the layers is against the standard. Thus, it is necessary to make consideration not to cause such a situation.

In order to prevent the cell from being recorded over the layers, there is a possible method of recording the cell up to near the tail of the recording area in the first layer and recording the next cell from the head of the recording area in the second layer. If this method is introduced, however, in some cases, an unrecorded area is generated after the last cell that is recorded in the first layer. Thus, if an appropriate process is not performed on the unrecorded area, that likely causes the DVD video standard violations according to circumstances. Moreover, in some process performed on the unrecorded area, some failures may be generated in video images and audio immediately before a layer change at the time of the reproduction of the dual-layer write-once type DVD on which the content data is recorded by the recording process.

As described above, it is not easy to record the content data in real time over the first layer and the second layer of the dual-layer write-once type DVD in compliance with the DVD video standard.

On the other hand, if the DVD video standard is not followed and a unique recording method is employed, it is released from the restriction that the cell is not to be recorded over the layers, or the like. Thus, it may be easier to record the content data in real time over the first layer and the second layer. However, if the unique recording method is employed, it is hardly possible to provide compatibility with competitors' products with regard to the recording and reproduction of the content data.

Secondly, in order to realize the real-time recording of the long content data, there is such a problem that it is likely necessary to increase the capacity of a buffer memory for encoding the content data.

For example, if a variable bit rate encoding method is employed for video data included in the content data, VOB (Video Object) becomes variable-length. Thus, until the encoding on one VOB is ended, search information, the end time of the VOB, and the like are hardly determined. For example, because of such a situation, many DVD recording apparatuses, which are currently spread, employ a method of storing one VOB of content data into the buffer memory, appending the search information, the end time of the VOB, and the like, which are determined by the encoding of the VOB after that encoding, and then recording the one VOB of content data into the recording area of the DVD. Thus, many DVD recording apparatuses, which are currently spread, are provided with the buffer memory having the capacity that can store at least one VOB of content data.

In this case, as the data size of the content data increases by the long-hour recording of by the recording at high transmission rate, the size of each VOB, which constitutes the content data, increases. For example, the number of the cells per one VTS (Video Title Set) is at most 255. If the size of the VTS including 255 cells increases, the size of each cell increases. As a result, the size of each VOB also increases. If the size of each VOB increases, it is necessary to increase the capacity of the buffer memory.

In order to solve the above-exemplified problems, it is therefore a first object of the present invention to provide a recording apparatus, a recording method, and a computer program, which can record the content data in real time over the first layer and the second layer of the dual-layer recording disk in compliance with the DVD video standard.

Moreover, a second object of the present invention is to provide a recording apparatus, a recording method, and a computer program, which can prevent the capacity of the buffer memory from increasing, when the content data is recorded in real time over the first layer and the second layer of the dual-layer recording disk.

### Means for Solving the Object

The above object of the present invention can be achieved by a first recording apparatus for recording content data over two layers of a dual-layer recording disk, the recording apparatus provided with: a first content data recording device for recording the content data into a recording area of a first layer of the dual-layer recording disk; a judging device for judging that the content data is recorded by the first content data recording device up to near a tail position of the recording area of the first layer; a first VTS formation processing device for performing a process for forming first VTS by using a portion of the content data which is recorded in the recording area of the first layer and a portion of the content data which is determined to be recorded into the recording area of the first layer, in accordance with a judgment result by the judging device; a second content data recording device for recording a remaining portion of the content data into a recording area of a second layer; and a second VTS formation processing device for performing a process for forming second VTS by using a portion of the remaining portion of the content data which is recorded in the recording area of the second layer and a portion of the remaining portion of the content data which is determined to be recorded into the recording area of the second layer, when the recording of the remaining portion of the content data is ended or stopped.

The above object of the present invention can be also achieved by a second recording apparatus for recording content data over two layers of a dual-layer recording disk, the recording apparatus provided with: a first area reserving device for ensuring a first reserved area to record therein first management information for a first data block, in a recording area of a first layer of the dual-layer recording disk; a first content data recording device for recording the content data from a position after the first reserved area in the recording area of the first layer; a judging device for judging that the content data is recorded by the first content data recording device up to near a tail position of the recording area of the first layer; a first data block formation processing device for performing a process for forming the first data block by using a portion of the content data which is recorded in the recording area of the first layer and a portion of the content data which is determined to be recorded into the recording area of the first layer, in accordance with a judgment result by the judging device; a second area reserving device for ensuring a second reserved area to record therein second management information for a second data block, between a remaining area of the recording area of the first layer after a portion of the content data, which forms the first data block, is recorded and a head area of a recording area of a second layer of the dual-layer recording disk; a second content data recording device for recording a remaining portion of the content data from a position after the second reserved area in the recording area of the second layer; a second data block formation processing device for performing a process for forming the second data block by using a portion of the remaining portion of the content data which is recorded in the recording area of the second layer and a portion of the remaining portion of the content data which is determined to be recorded into the recording area of the second layer, when the recording of the remaining portion of the content data is ended or stopped; a first management information recording device for recording the first management information into the first reserved area; and a second management information recording device for recording the second management information into the second reserved area.

The above object of the present invention can be also achieved by a first recording method of recording content data over two layers of a dual-layer recording disk, the recording method provided with: a first content data recording process of recording the content data into a recording area of a first layer of the dual-layer recording disk; a judging process of judging that the content data is recorded in the first content data recording process up to near a tail position of the recording area of the first layer; a first VTS formation processing process of performing a process for forming first VTS by using a portion of the content data which is recorded in the recording area of the first layer and a portion of the content data which is determined to be recorded into the recording area of the first layer, in accordance with a judgment result in the judging process; a second content data recording process of recording a remaining portion of the content data into a recording area of a second layer; and a second VTS formation processing process of performing a process for forming second VTS by using a portion of the remaining portion of the content data which is recorded in the recording area of the second layer and a portion of the remaining portion of the content data which is determined to be recorded into the recording area of the second layer, when the recording of the remaining portion of the content data is ended or stopped.

The above object of the present invention can be also achieved by a second recording method of recording content data over two layers of a dual-layer recording disk, the recording method provided with: a first area reserving process of ensuring a first reserved area to record therein first management information for a first data block, in a recording area of a first layer of the dual-layer recording disk; a first content data recording process of recording the content data from a position after the first reserved area in the recording area of the first layer; a judging d process of judging that the content data is recorded in the first content data recording process up to near a tail position of the recording area of the first layer; a first data block formation processing process of performing a process for forming the first data block by using a portion of the content data which is recorded in the recording area of the first layer and a portion of the content data which is determined to be recorded into the recording area of the first layer, in accordance with a judgment result in the judging process; a second area reserving process of ensuring a second reserved area to record therein second management information for a second data block, between a remaining area of the recording area of the first layer after a portion of the content data, which forms the first data block, is recorded and a head area of a recording area of a second layer of the dual-layer recording disk; a second content data recording process of recording a remaining portion of the content data from a position after the second reserved area in the recording area of the second layer; a second data block formation processing process of performing a process for forming the second data block by using a portion of the remaining portion of the content data which is recorded in the recording area of the second layer and a portion of the remaining portion of the content data which is determined to be recorded into the recording area of the second layer, when the recording of the remaining portion of the content data is ended or stopped; a first management information recording process of recording the first management information into the first reserved area; and a second management information recording process of recording the second management information into the second reserved area.

The above object of the present invention can be also achieved by a computer program for making a computer function as the first or second recording apparatus of the present invention (including its various aspects).

The above object of the present invention can be also achieved by a first or second computer program products in a computer-readable medium for tangibly embodying a program of instructions executable by a computer, to make the computer function as the first or second recording apparatuses of the present invention (including its various aspects).

According to each of the computer program products of the present invention, the aforementioned first or second recording apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disk or the like, into the computer, or by downloading the computer program product, which may be a carrier wave, into the computer via a communication device. More specifically, each of the computer program products may include computer readable codes to cause the computer (or may comprise computer readable instructions for causing the computer) to function as respective one of the aforementioned first or second recording apparatus of the present invention.

These effects and other advantages of the present invention will become more apparent from the following embodiment.

### BRIEF DESCRIPTION OF DRAWINGS

FIG. 1 is a block diagram showing the structure of a recording/reproducing apparatus in an embodiment of the recording apparatus and the recording method of the present invention.

FIG. 2 is a flowchart showing an operation of real-time recording of the content data on the recording/reproducing apparatus in FIG. 1.

FIG. 3 is an explanatory diagram showing an unrecorded dual-layer write-once type DVD.

FIG. 4 is an explanatory diagram showing a first recording state of the dual-layer write-once type DVD in the real-time recording operation of the content data in FIG. 2.

FIG. 5 is an explanatory diagram showing a second recording state of the dual-layer write-once type DVD in the real-time recording operation of the content data in FIG. 2.

FIG. 6 is an explanatory diagram showing a third recording state of the dual-layer write-once type DVD in the real-time recording operation of the content data in FIG. 2.

FIG. 7 is an explanatory diagram showing a fourth recording state of the dual-layer write-once type DVD in the real-time recording operation of the content data in FIG. 2.

FIG. 8 is an explanatory diagram showing a fifth recording state of the dual-layer write-once type DVD in the real-time recording operation of the content data in FIG. 2.

FIG. 9 is an explanatory diagram showing a sixth recording state of the dual-layer write-once type DVD in the real-time recording operation of the content data in FIG. 2.

FIG. 10 is an explanatory diagram showing a seventh recording state of the dual-layer write-once type DVD in the real-time recording operation of the content data in FIG. 2.

FIG. 11 is an explanatory diagram showing such a state that the content data is additionally recorded (or written once) by the recording/reproducing apparatus in FIG. 1 onto the dual-layer write-once type DVD on which another content data is already recorded up to the middle of the recording area of the first layer.

FIG. 12 is an explanatory diagram showing such a state that backup information about VTSI of first VTS and VTSI of second VTS are recorded in a reserved area.

FIG. 13 is an explanatory diagram showing such a state that the backup information about the VTSI of the first VTS and the VTSI of the second VTS are recorded in the reserved area.

FIG. 14 is an explanatory diagram showing such a state that backup information about VTSI of first VTS and VTSI of second VTS are recorded in a reserved area.

### DESCRIPTION OF REFERENCE CODES

1 recording/reproducing apparatus
10 dual-layer write-once type DVD
16 video encoder
17 audio encoder
19 recording control device
30 system control device

### BEST MODE FOR CARRYING OUT THE INVENTION

Hereinafter, the best mode for carrying out the present invention will be explained in each embodiment in order with reference to the drawings.

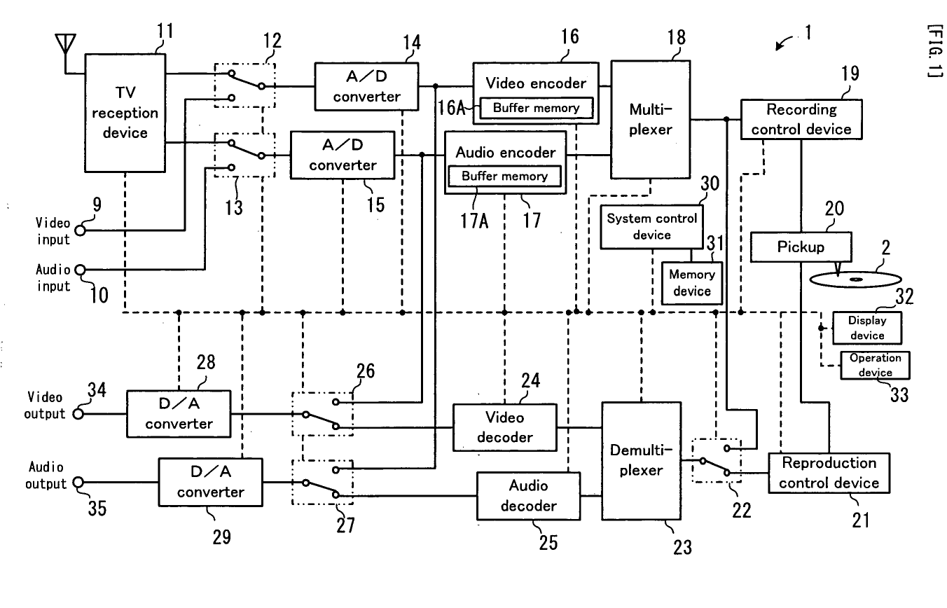

FIG. 1 shows the structure of a recording/reproducing apparatus in an embodiment of the recording apparatus and the recording method of the present invention. A recording/reproducing apparatus 1 in FIG. 1 can record the content data in real time over a first layer and a second layer of a single-sided dual-layer write-once type DVD 2.

With regard to the recording/reproducing apparatus 1 in FIG. 1, the structure and the operation regarding the recording of the content data are as follows. A TV broadcast station transmits an analog video signal and an analog audio signal. Incidentally, the video signal and the audio signal correspond to unencoded data, which is the content data that has not been encoded yet. A TV reception device 11 receives the video signal and the audio signal, which are transmitted from the TV broadcast station. The video signal and the audio signal are supplied to A/D converters 14 and 15 through input selector switches 12 and 13, and are converted to a digital video signal and a digital audio signal by the A/D converters 14 and 15, respectively. Then, a video encoder 16 encodes the video signal on the basis of the DVD video standard. If the encoding process is performed by the video encoder 16, the video signal is temporarily stored in a buffer memory 16A for a video encoding process, and the encoding process is performed on the video signal stored in the buffer memory 16A. Moreover, an audio encoder 17 encodes the audio signal. Similarly, if the encoding process is performed by the audio encoder 17, the audio signal is temporarily stored in a buffer memory 17A for an audio encoding process, and the encoding process is performed on the audio signal stored in the buffer memory 17A. The encoded video signal and the encoded audio signal are combined by a multiplexer 18 and are supplied to a recording control device 19. Incidentally, the video signal and the audio signal, which are combined by the multiplexer 18, are the content data that is recorded onto the dual-layer write-once type DVD 2. Then, the recording control device 19 controls a pickup 20′ and records the content data onto the dual-layer write-once type DVD 2. Incidentally, the recording/reproducing apparatus 1 can also record a video signal and an audio signal, which are filmed and recorded by e.g. a video camera, onto the dual-layer write-once type DVD 2 through external input terminals 9 and 10. The video signal and the audio signal, which are inputted from the video camera to the recording/reproducing apparatus 1 through the external input terminals 9 and 10, correspond to the unencoded data, which is the content data that has not been encoded yet.

On the other hand, with regard to the recording/reproducing apparatus 1, the structure and the operation regarding the reproduction of the content data are as follows. The content data recorded on the dual-layer write-once type DVD 2 is read by the pickup 20, under the control of a reproduction control device 21, and is supplied to a demultiplexer 23 through a selector switch 22. The content data is divided into the video signal and the audio signal by the demultiplexer 23. The video signal is decoded by a video decoder 24, and the audio signal is decoded by an audio decoder 25. The decoded video signal and the decoded audio signal are supplied to D/A converters 28 and 29 through selector switches 26 and 27, are converted to an analog video signal and an analog audio signal by the D/A converters 28 and 29, and are outputted through output terminal 34 and 35, respectively.

A system control device 30 controls each of the constituent elements of the recording/reproducing apparatus 1, such as the TV reception device 11, the A/D converters 14 and 15, the encoders 16 and 17, the VOB formation device 18, and the decoders 24 and 25. Specifically, the system control device 30 controls the recording control device 19, to thereby perform a real-time recording process of recording the content data on the dual-layer write-once type DVD 2. Each of the system control device 30 and the recording control device 19 is formed of, e.g., an arithmetic processing apparatus, a memory element, and the like. Moreover, the recording/reproducing apparatus 1 is provided with: a memory device 31; a display device 32; and an operation device 33.

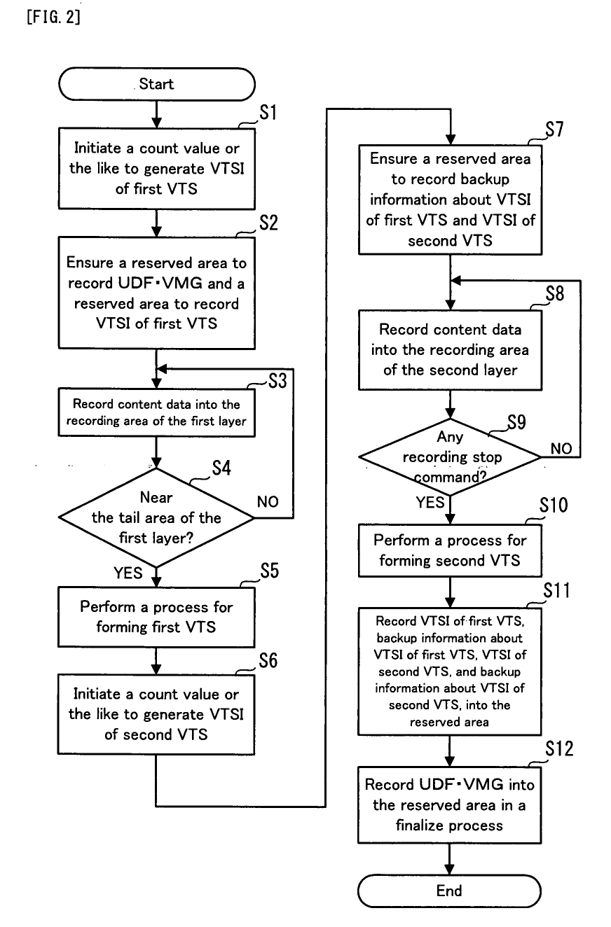

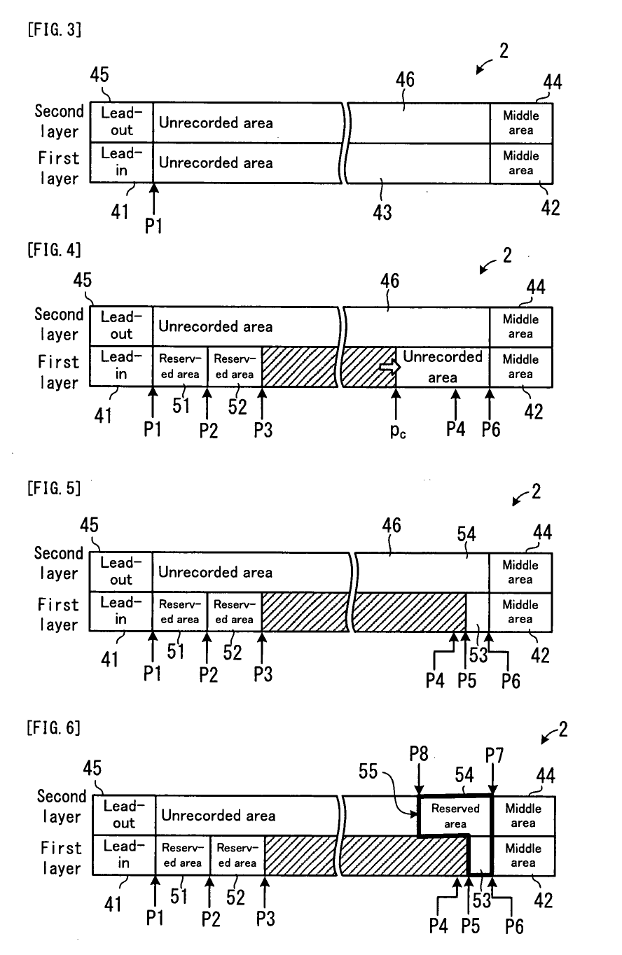

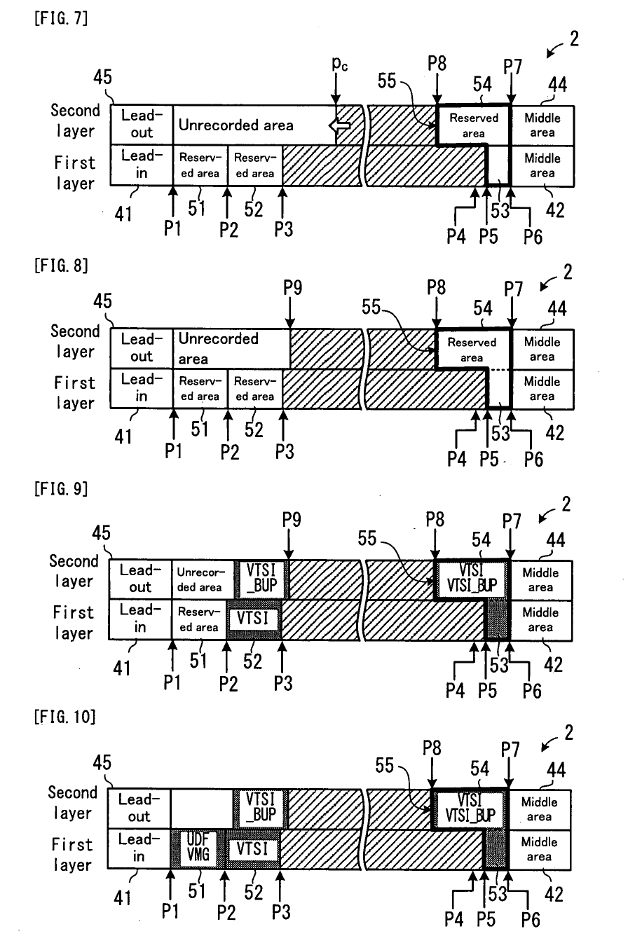

FIG. 2 shows the operation of the real-time recording of recording the content data on the dual-layer write-once type DVD 2. FIG. 3 to FIG. 10 show recording states of the dual-layer write-once type DVD 2 in a process of the real-time recording operation. FIG. 3 to FIG. 10 show spiral tracks, formed in the first layer and the second layer of the dual-layer write-once type DVD 2, in such a state that the tracks are linearly elongated from side to side. In each drawing, the lower part is the first layer (layer 0), and the upper part is the second layer (layer 1). Moreover, in the following explanation based on FIG. 3 to FIG. 10, the following case is exemplified: the content data having a data size which exceeds the recording capacity of the first layer of the dual-layer write-once type DVD 2 is recorded in real time onto the unrecorded dual-layer write-once type DVD 2.

FIG. 3 shows the unrecorded dual-layer write-once type DVD 2. A lead-in area 41 is formed in the innermost portion of the first layer of the dual-layer write-once type DVD 2, and a middle area 42 is formed in the outermost portion of the first layer. The content data is not recorded in these portions. In the first layer, a recording area 43 is formed between the lead-in area 41 and the middle area 42. The content data is recorded into the recording area 43. On the other hand, a middle area 44 is formed in the outermost portion of the second layer, and a lead-out area 45 is formed in the innermost portion of the second layer. The content data is not recorded in these portions. In the second layer, a recording area 46 is formed between the middle area 44 and the lead-out area 45. The content data is also recorded in the recording area 46.

Now it is assumed that the unrecorded dual-layer write-once type DVD 2, as shown in FIG. 3, is loaded in a disk loading portion (not illustrated) of the recording/reproducing apparatus 1. In this state, the video signal and the audio signal, which are transmitted from the TV broadcast station, are received by the TV reception device 11, or the video signal and the audio signal, which are outputted from the video camera, are inputted to the recording/reproducing apparatus 1 through the external input terminals 9 and 10. Then, for example, a user presses a recording start button (not illustrated) mounted on the operation device 33. In response to this, the recording control device 19 starts the real-time recording of recording the content data, under the control of the system control device 30. Since the dual-layer write-once type DVD 2 is unrecorded, the real-time recording of the content data is started from a position P1, which is the innermost position of the recording area 43 of the first layer.

Firstly, the recording control device 19 initiates a count value or the like for generating information which is necessary to generate VTSI (Video Title Set Information) of first VTS (step S1 in FIG. 2). For example, the recording control device 19 initiates a count value for counting a cell number, a count value for writing the address of each cell, a count value for measuring a cell reproduction time, and the like.

Then, as shown in FIG. 4, the recording control device 19 ensures two reserved areas 51 and 52 in the recording area 43, before the actual recording of the content data is started (step S2 in FIG. 2). That is, the recording control device 19 firstly ensures the reserved area 51 between the head position P1 of the recording area 43 and a position P2. The reserved area 51 is an area to record therein UDF (Universal Disk Format) information and VMG (Video Manager). The size (or the position of P2) of the reserved area 51 desirably corresponds to the data size in which the UDF information and the VMG are combined. Incidentally, a UDF is a standard format to manage the position, size, or the like of each content, which exists on storage media, and the UDF information is information about the UDF. The VMG is one of the management information on the DVD video standard, and the VMG includes management information, menu information, and the like, for the overall control of the information recorded on the disk. Then, the recording control device 19 ensures the reserved area 52 between a position which follows the position P2 and a position P3. The reserved area 52 is an area to record therein the VTSI of the first VTS, which is recorded in the first layer. The size (or the position of P3) of the reserved area 52 desirably corresponds to the data size of the VTSI. Incidentally, the VTS includes the content data for constituting a certain title. The VTSI is control information and management information about the VTS. The recording of the UDF information and the VMG into the reserved area 51 and the recording of the VTSI into the reserved area 52 are not performed at this stage. The reserved areas 51 and 52 are still unrecorded at this stage.

Then, the recording control device 19 actually records the content data, which is encoded by the video encoder 16 and the audio encoder 17 and is combined by the multiplexer 18, into the recording area 43. That is, the recording control device 19 records the content data from a position after the reserved area 52 in the recording are 43, specifically, a position which follows the position P3, as shown in FIG. 4 (step S3 in FIG. 2). A shaded portion in FIG. 4 indicates the state that the content data is actually recorded. Moreover, a white arrow in FIG. 4 indicates the direction that the content data is recorded.

On the recording/reproducing apparatus 1, since the encoding process on the video signal and the audio signal is performed in each VOB, the content data is also recorded in each VOB. That is, when the encoding process is performed by the video encoder 16, the video signal is temporarily stored into the buffer memory 16A, and the encoding process is performed on the video signal stored in the buffer memory 16A. Then, by the encoding process, a video data block for forming one VOB is formed by using the video signal stored in the buffer memory 16A. Moreover, when the encoding process is performed by the audio encoder 17, the audio signal is temporarily stored into the buffer memory 17A, and the encoding process is performed on the audio signal stored in the buffer memory 17A. Then, by the encoding process, an audio data block for forming one VOB is formed by using the audio signal stored in the buffer memory 17A. Then, the video data block and the audio data block are combined by the multiplexer 18, and one VOB is formed. Then, the one VOB is outputted to the recording control device 19 and is recorded onto the dual-layer write-once type DVD 2, under the control of the recording control device 19.

Then, the system control device 30 judges whether or not the content data is recorded up to near a tail position P6 of the recording area 43 of the first layer (step S4). This judgment is performed as follows, for example. That is, the system control device 30 calculates a value obtained by subtracting a value which indicates the amount of data corresponding to one to several VOBUs (Video Object Unit) from a value which indicates the amount of data which can be recorded into an unrecorded area of the recording area 43 of the first layer before the recording of the content data is started, and it holds the value as a reference value Vᵣ. Moreover, the system control device 30 integrates the amount of the content data, which is encoded by the encoders 16 and 17 to perform the recording into the recording area 43, and the amount of the management information added to the content data, and it holds an integrated value vₐ which indicates the above. That is, the integrated value vₐ is equal to a value obtained by adding a total length of one or more VOBs, which are already recorded in the recording area 43 by the recording control device 19, and a total length of the management information and the content data, which are currently stored in the buffer memories 16A and 17A after the encoding process for forming the VOB which will be recorded next. The integrated value vₐ increases in response to the progress of the encoding process performed by the encoders 16 and 17. Moreover, the system control device 30 compares the integrated value vₐ with the reference value Vᵣ while the encoding process is performed by the encoders 16 and 17. Then, when the integrated value vₐ exceeds the reference value Vᵣ, the system control device 30 judges that the content is recorded up to near the tail position P6 in the recording area 43 of the first layer. Incidentally, a position P4 in FIG. 4 indicates a position on the recording area 43 corresponding to the reference value Vᵣ. The position P4 is located, by the data size corresponding to one or several VOBUs, in front of (or on the inner circumferential side of) the tail position P6 of the recording area 43 of the first layer.

If it is judged that the content data is recorded up to near the tail position P6 of the recording area 43 of the first layer (the step S4: YES), the recording control device 19 performs a process for forming the first VTS by using the content data which is already recorded in the recording area 43 of the first layer or the content data which is determined to be recorded into the recording area 43 (step S5).

That is, the recording control device 19 or the system control device 30 issues a command to perform a close process on the data block (e.g. a command to close the cell) to the video encoder 16 and the audio encoder 17. In response to this, the video encoder 16 performs the close process. That is, the video encoder 16 forms the video data block for forming one VOB, by using the video signal which is currently being encoded, i.e. the video signal which is currently stored in the buffer memory 16A. Specifically, the video encoder 16 generates the search information about the VOB, information about the end time of the VOB, or the like, and appends them to the video data block. Substantially in the same manner, the audio encoder 17 also performs the close process in response to the command to perform the close process. That is, the audio encoder 17 forms the audio data block for forming one VOB, by using the audio signal which is currently being encoded, i.e. the audio signal which is currently stored in the buffer memory 17A. Moreover, the video data block and the audio data block are determined to be recorded into the recording area 43. Incidentally, the video encoder 16 and the audio encoder 17 immediately perform the close process in accordance with the command to perform the close process. By this, the sizes of the video data block and the audio data block are sometimes less than those of the video data block and the audio data block which form the normal VOB. As a result, the size of the VOB formed by using the video data block and the audio data block which are formed in accordance with the command is sometimes less than the size of the normal VOB. Then, the recording control device 19 forms the first VTS by using the content data which is already recorded in the recording area 43 at this stage and the content data which is stored in the buffer memories 16A and 17A at this stage (i.e. the content data which is determined to be recorded into the recording area 43). That is, the recording control device 19 forms one VTS by using one or more VOBs which are already recorded in the recording area 43 at this stage and one VOB which is stored in the buffer memories 16A and 17A at this stage. Specifically, the recording control device 19 generates the VTSI of the first VTS and backup information about the VTSI (or VTSI backup). Incidentally, the generated VTSI and the generated backup information about the VTSI are not recorded onto the dual-layer write-once type DVD 2 at this stage and are held in a predetermined area of another buffer memory (not illustrated).

Moreover, the recording control device 19 issues a command to perform closed-GOP (Group Of Pictures) encoding on the video signal which will be encoded next, to the video encoder 16, together with the command to perform the close process on the video signal which is currently being encoded. In response to this command, the video encoder 16 performs the closed-GOP-encoding on a head portion of the video signal which will be encoded next. The closed-GOP-encoded GOP is disposed at the head of the content data (or the video data) which forms second VTS.

Then, as shown in FIG. 5, the recording control device 19 records the content data about one VOB, which is stored in the buffer memories 16A and 17A at this stage, into the recording area 43. As a result, the content data is recorded up to a position P5 in the recording area 43 of the first layer. Incidentally, the content data recorded between a position which follows the position P3 and the position P5 is the content data for forming the first VTS.

Then, the recording control device 19 initiates a count value or the like for generating information which is necessary to generate VTSI of the second VTS (step S6). For example, the recording control device 19 initiates a count value for counting a cell number, a count value for writing the address of each cell, a count value for measuring a cell reproduction time, and the like.

Then, as shown in FIG. 6, the recording control device 19 ensures a reserved area 55 between a remaining area 53 of the recording area 43 of the first layer after the content data for forming the first VTS is recorded and a head area 54 of the recording area 46 of the second layer (step S7 in FIG. 2). That is, the recording control device 19 ensures a former portion of the reserved area 55 between a position which follows the position P5 in the recording area 43 of the first layer and the tail position P6 of the recording area 43. Then, the recording control device 19 ensures a latter portion of the reserved area 55 between a head position P7 of the recording area 46 of the second layer and a position P8. The reserved area 55 is an area for recording the backup information about the VTSI of the first VTS and the VTSI of the second VTS. The extent (or the position of P8) of the reserved area 55 desirably corresponds to the data size in which the backup information about the VTSI of the first VTS and the VTSI of the second VTS are combined. The recording of the backup information about the VTSI of the first VTS and the VTSI of the second VTS into the reserved area 55 is not performed at this stage. The reserved area 55 is unrecorded at this stage.

Then, the recording control device 19 changes the layer in which the content data is recorded, from the first layer to the second layer. Then, the recording control device 19 records the content data from a position after the reserved area 55 in the recording area 46 of the second layer, i.e. from a position which follows the position P8 (step S8 in FIG. 2). This content data is the content data which is encoded following the content data recorded at the position P5 in the recording area 43 of the first layer and whose content is continued from that of the content data recorded at the position P5 in the recording area 43. Incidentally, a position (or address) at which the recording of the content data is started in the recording area 46 can be specified by an operation or calculation at the stage that the process of forming the first VTS (step S5 in FIG. 2) is completed.

Incidentally, the recording/reproducing apparatus 1 performs the process of forming the first VTS, the ensuring of the reserved area 55, and the recording of the content data into the recording area 46, while continuing the encoding process. That is, while the recording control device 19 performs the process of forming the first VTS, the ensuring of the reserved area 55, and the recording of the content data into the recording area 46, the video encoder 16 and the audio encoder 17 continue the encoding process on the video signal and the audio signal. Specifically, after the encoding process on the VOB, which is to be recorded into the recording area 43 of the first layer, the video encoder 16 and the audio encoder 17 continuously perform the encoding process on the VOB, which is to be recorded into the recording area 46 of the second layer. As described above, it is possible to realize the real-time recording of the content data over the first layer and the second layer, by continuously performing the encoding process while performing the process of forming the first VTS, the ensuring of the reserved area 55, and the recording of the content data into the recording area 46.

After that, a user presses a recording stop button (not illustrated) mounted on the operation device 33. By this, a recording stop command is issued from the system control device 30, and the recording of the content data is stopped (step S9: YES). In response to this, the recording control device 19 performs a process for forming the second VTS by using the content data which is already recorded in the recording area 46 of the second layer and the content data which is determined to be recorded into the recording area 46 (step S10). That is, the recording control device 19 issues the command to perform the close process on the data block, to the video encoder 16 and the audio encoder 17. In response to this command, the video encoder 16 forms the video data block for forming one VOB, by using the video signal which is currently stored in the buffer memory 16A. Moreover, the audio encoder 17 also forms the audio data block for forming one VOB, by using the audio signal which is currently stored in the buffer memory 17A, in response to the command to perform the close process. Then, the recording control device 19 forms the second VTS by using the content data which is already recorded in the recording area 46 at this stage and the content data which is stored in the buffer memories 16A and 17A at this stage (i.e. the content data which is determined to be recorded into the recording area 46). That is, the recording control device 19 forms one VTS by using one or more VOBs which are already recorded in the recording area 46 at this stage and one VOB which is stored in the buffer memories 16A and 17A at this stage. Specifically, the recording control device 19 generates the VTSI of the second VTS and backup information about the VTSI (or VTSI backup).

Then, as shown in FIG. 8, the recording control device 19 records the content data about one VOB stored in the buffer memories 16A and 17A at this stage, into the recording area 46. As a result, the content data is recorded up to a position P9 in the recording area 46 of the second layer. Moreover, the content data recorded between a position which follows the position P8 and the position P9 in the recording area 46 of the second layer is the content data for forming the second VTS.

Then, as shown in FIG. 9, the recording control device 19 records the VTSI of the first VTS into the reserved area 52, records the backup information about the VTSI of the first VTS and the VTSI of the second VTS into the reserved area 55, and records the VTSI of the second VTS into an area which follows the position P9 in the recording area 46 (step S11 in FIG. 2). By this, the first VTS is formed by using the VTSI recorded in the reserved area 52, the content data recorded in the recording area 43, and the backup information about the VTSI recorded in the reserved area 55. Moreover, the second VTS is formed by using the VTSI recorded in the reserved area 55, the content data recorded in the recording area 46, and the backup information about the VTSI recorded following this content data.

After that, if a finalize process is performed on the dual-layer write-once type DVD 2, the UDF information and the VMG are recorded into the reserved area 51, as shown in FIG. 10. Moreover, if there is a remaining unrecorded area in a direction to the tail position in the recording area 46 of the second layer, for example, NULL data is recorded into the unrecorded area (step S12 in FIG. 2).

As explained above, the recording/reproducing apparatus 1 forms the first VTS by using the content data which is recorded in the recording area 43 of the first layer and forms the second VTS by using the content data which is recorded in the recording area 46 of the second layer when recording the content data over the first layer and the second layer of the dual-layer write-once type DVD 2. According to the recording/reproducing apparatus 1, although the content data is divided into two VTSs, it performs the process of recording the content data into the recording area 43 of the first layer and the process of recording the content data into the recording area 46 of the second layer while continuing the encoding process on the content data, so that it is possible to record the content data in real time over the first layer and the second layer.

Moreover, according to the recording/reproducing apparatus 1, since it forms the first VTS by using the content data which is recorded in the recording area 43 of the first layer and forms the second VTS by using the content data which is recorded in the recording area 46 of the second layer, the cell is not recorded over the first layer and the second layer. Therefore, it is possible to record the content data over the first layer and the second layer of the dual-layer write-once type DVD 2 in compliance with the DVD video standard. Thus, it is possible to provide compatibility with competitors' products with regard to the recording and reproduction of the content data.

Moreover, according to the recording/reproducing apparatus 1, since it forms the first VTS by using the content data which is recorded in the recording area 43 of the first layer and forms the second VTS by using the content data which is recorded in the recording area 46 of the second layer, it is possible to reproduce all the content data recorded over the first layer and the second layer of the dual-layer write-once type DVD 2. Moreover, it is possible to maintain the same reproduction quality as that in a single-layer write-once type DVD. That is, it is possible to prevent some failures from being generated in video images and audio, such as nothing is displayed on a screen immediately before a layer change, a noise is displayed on the screen, or no sound is produced, when the content data is reproduced.

Moreover, according to the recording/reproducing apparatus 1, since it divides the content data into the content data which forms the first VTS to be recorded into the recording area 43 of the first layer and the content data which forms the second VTS to be recorded into the recording area 46 of the second layer, it is possible to prevent the capacities of the buffer memories 16A and 17A for the encoding process from increasing. That is, according to the recording/reproducing apparatus 1, the size of each VTS does not exceed the extent of the recording area in each layer of the dual-layer write-once type DVD. Moreover, the extent of the recording area in each layer of the dual-layer write-once type DVD does not exceed the extent of the recording area of a single-layer write-once type DVD. Therefore, the size of the VOB which constitutes each VTS is substantially equal to or less than the size of the VOB which constitutes each VTS in the case that the content data is recorded onto the single-layer write-once type DVD. As described above, the buffer memory for the encoding process has a capacity that enables one VOB to be stored. If so, the size of the VOB does not significantly change. Thus, it is unnecessary to increase the capacities of the buffer memories 16A and 17A. Therefore, if the recording/reproducing apparatus is manufactured with the function of recording the content data onto the dual-layer write-once type DVD, it is possible to use the buffer memory used for the recording/reproducing apparatus provided with the function of recording the content data onto the single-layer write-once type DVD, i.e. the buffer memory which is conventionally mass-produced and which is available inexpensively. Moreover, in some cases, there is no need to change a design for the circuit substrate of the recording/reproducing apparatus. Thus, it is possible to realize a reduction in cost of manufacturing the recording/reproducing apparatus provided with the function of recording the content data onto the dual-layer write-once type DVD, a reduction in a development period, or the like.

Incidentally, in the recording/reproducing apparatus 1, the recording control device 19 and the system control device 30 are a specific example of the first content data recording device, the judging device, the first VTS formation processing device, the second content data recording device, the second VTS formation processing device, the area reserving device, the management information recording device, the backup information recording device, the first area reserving device, the first data block formation processing device, the second area reserving device, the second data block formation processing device, the first management information recording device, and the second management information recording device of the present invention. More specifically, the step S3 in FIG. 2 is a specific example of the first content data recording device. The step S4 is a specific example of the judging device. The step S5 is a specific example of the first VTS formation processing device. The step S8 is a specific example of the second content data recording device. The step S10 is a specific example of the second VTS formation processing device. The step S7 is a specific example of the area reserving device. The step S11 is a specific example of the management information recording device and the backup information recording device. Moreover, the step S2 is a specific example of the first area reserving device. The step S5 is a specific example of the first data block formation processing device. The step S7 is a specific example of the second area reserving device. The step S10 is a specific example of the second data block formation processing device. The step S11 is a specific example of the first management information recording device and the second management information recording device. Moreover, the video encoder 16, the audio encoder 17, and the multiplexer 18 are a specific example of the encoding device.

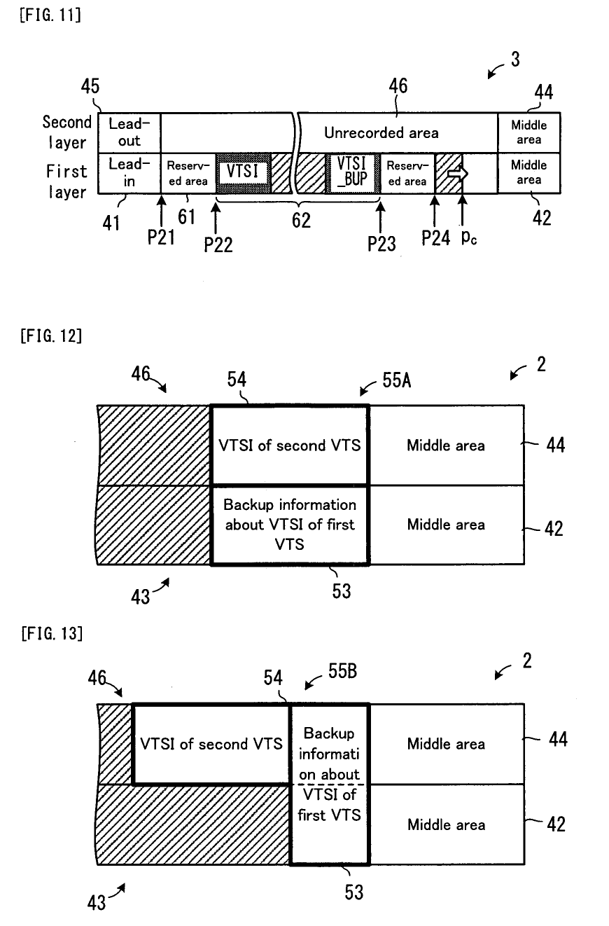

Moreover, the aforementioned explanation exemplifies the case that the content data is recorded into the unrecorded dual-layer write-once type DVD. The recording/reproducing apparatus 1, however, can additionally record (or write once) the content data onto the dual-layer write-once type DVD on which another content data (or another VTS) or the like is already recorded. FIG. 11 shows such a state that new content data is additionally recorded (or written once) onto the dual-layer write-once type DVD on which another content data (or another VTS) is already recorded in the recording area of the first layer. As shown in FIG. 11, a reserved area 61 for recording the UDF information and the VMG is ensured between a head position P21 and a position P22 in the recording area of the first layer of a dual-layer write-once type DVD 3. This is ensured when another content data (or another VTS 62) is recorded. Moreover, another content data (or another VTS 62) is recorded between a position which follows the position P22 and a position P23. The recording control device 19 of the recording/reproducing apparatus 1 initiates the count value or the like for generating the information which is necessary to generate the VTSI of the VTS, which will be formed from now, and then ensures the reserved area to record therein the VTSI, between a position after the area in which another content data (or another VTS 62) is recorded, specifically a position which follows the position P23, and a position P24. Then, the recording control device 19 records new content data, from a position after the reserved area, specifically from a position which follows the position P24. The operation after this is the same as the aforementioned real-time recording operation (after the step S3 in FIG. 3).

Moreover, as described above, the system control device 30 judges whether or not the content data is recorded up to near the tail position P6 of the recording area 43 of the first layer (the step S4 in FIG. 2). As the judging method, the aforementioned explanation exemplifies the method of judging that the content data is recorded up to near the tail position P6 of the recording area 43 when the integrated value vₐ exceeds the reference value Vᵣ. The judging method, however, is not limited to this. For example, as shown in FIG. 4, it may be judged that the content data is recorded up to near the tail position P6 of the recording area 43 when a current recording position p_{c} exceeds the position P4 in the comparison of the current recording position p_{c} in the recording area 43 and the position P4. In this case, the position P4 is set such that the extent of the area between the tail position P6 of the recording area 43 and the position P4 corresponds to the size of the normal one VOB, for example.

Moreover, as described above, after the process for forming the first VTS, the recording control device 19 initiates the count value or the like for generating the information which is necessary to generate the VTSI of the second VTS (the step S6). However, if the cell which forms the second VTS, the address of each cell, which forms the second VTS, or the like can be specified when the process for forming the second VTS is performed (the step S10), the count value does not have to be initialized in the step S6. For example, if the cell number corresponding to the cell which forms the second VTS is marked, it is possible to specify the cell which forms the second VTS, the address of each cell which forms the second VTS, or the like.

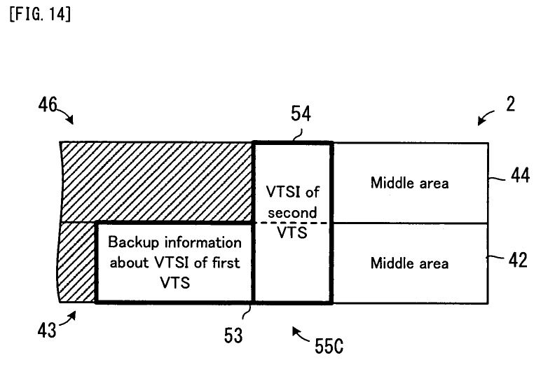

Moreover, as described above, the recording control device 19 of the recording/reproducing apparatus 1 ensures the reserved area 55 between the remaining area 53 of the recording area 43 of the first layer after the content data for forming the first VTS is recorded and the head area 54 of the recording area 46 of the second layer (the step S7 in FIG. 2). Then, the recording control device 19 records the backup information about the VTSI of the first VTS and the VTSI of the second VTS into the reserved area 55 (the step S11). At this time, the arrangement of the backup information about the VTSI of the first VTS and the VTSI of the second VTS in the reserved area 55 is not particularly limited. FIG. 12 to FIG. 14 show the reserved area 55 of the dual-layer write-once type DVD 2. As shown in FIG. 12, the backup information about the VTSI of the first VTS may be recorded into the remaining area 53 of the recording area 43 of the first layer, and the VTSI of the second VTS may be recorded into the head area 54 of the recording area 46 of the second layer. Alternatively, as shown in FIG. 13, the backup information about the VTSI of the first VTS may be recorded over the remaining area 53 and the head area 54, and the VTSI of the second VTS may be recorded into the head area 54. Alternatively, as shown in FIG. 14, the backup information about the VTSI of the first VTS may be recorded into the remaining area 53, and the VTSI of the second VTS may be recorded over the remaining area 53 and the head area 54. Intentional control may be performed to give any one of the arrangements shown in FIG. 12 to FIG. 14, but such control may not be performed. That is, the backup information about the VTSI of the first VTS and the VTSI of the second VTS may be recorded sequentially into the reserved area 55 (or the remaining area 53 and the head area 54). By this, the arrangement of the backup information about the VTSI of the first VTS and the VTSI of the second VTS is as any one of the arrangements shown in FIG. 12 to FIG. 14, in response to the extent of the remaining area 53 (or the extent of the content data which forms the first VTS, i.e. the position of P5 in FIG. 5).

Moreover, the aforementioned explanation exemplifies the case that the recording of the VTSI of the first VTS into the reserved area 52, the recording of the backup information about the VTSI of the first VTS and the VTSI of the second VTS into the reserved area 55, and the recording of the VTSI of the second VTS into the recording area 46 are performed at a time after the recording of the content data, which forms the second VTS, into the recording area 46. The present invention, however, is not limited to this. For example, the recording of the VTSI of the first VTS into the reserved area 52 and the recording of the backup information about the VTSI of the first VTS into the reserved area 55 may be performed before the recording of the content data into the recording area 46.

Moreover, the recording/reproducing apparatus 1 receives the analog video signal and the analog audio signal from the TV broadcast station or the video camera, converts them to the digital video signal and the digital audio signal, encodes them, and records them. The present invention is not limited to this. It may receive the digital video signal and the digital audio signal, encode them, and record them. Moreover, it may receive the video signal and the audio signal, which are already encoded by the DVD video standard, divide them into the content data which forms the first VTS and the content data which forms the second VTS, record the content data which forms the first VTS into the recording area 43 of the first layer, and record the content data which forms the second VTS into the recording area 46 of the second layer. Moreover, the present invention can be also applied to a recording apparatus without a reproduction function of reproducing the content data. Moreover, the signal supply source for supplying the video signal and the audio signal to the recording apparatus is not limited to the TV broadcast station, the video camera, or the like. Moreover, the content data is not limited to the video signal and the audio signal. Moreover, the content data may be only the video signal.

Moreover, the recording apparatus of the present invention is not limited to AV equipment, such as a DVD recorder, but it can be realized by making a computer read a computer program. In this case, a computer program is prepared to realize the functions of the recording control device 19, the system control devices 30 or the like, i.e. the first content data recording device, the judging device, the first VTS formation processing device, the second content data recording device, the second VTS formation processing device or the like.

Moreover, although the case that the information is recorded onto the dual-layer write-once type DVD (e.g. a dual-layer DVD-R) is exemplified, the recording apparatus of the present invention can be also applied to a dual-layer rewritable type DVD (e.g. a dual-layer DVD-RW).

Moreover, in the present invention, various changes may be made, if desired, without departing from the essence or spirit of the invention which can be read from the claims and the entire specification. A recording apparatus, a recording method, and a computer program which realizes these functions, all of which involve such changes, are also intended to be within the technical scope of the present invention.

### INDUSTRIAL APPLICABILITY

The recording apparatus and the recording method for dual-layer recording disk according to the present invention can be applied to a recording apparatus, such as a DVD recorder, which records the content data onto an optical disk having two recording layers, such as a DVD.

1-11. (canceled)

12. A recording apparatus for recording content data over two layers of a dual-layer recording disk, said recording apparatus comprising:
a first content data recording device for recording the content data into a recording area of a first layer of the dual-layer recording disk;
a judging device for judging that the content data is recorded by said first content data recording device up to near a tail position of the recording area of the first layer;
a first VTS formation processing device for performing a process for forming first VTS by using a portion of the content data which is recorded in the recording area of the first layer and a portion of the content data which is determined to be recorded into the recording area of the first layer, in accordance with a judgment result by said judging device;
a second content data recording device for recording a remaining portion of the content data into a recording area of a second layer;
a second VTS formation processing device for performing a process for forming second VTS by using a portion of the remaining portion of the content data which is recorded in the recording area of the second layer and a portion of the remaining portion of the content data which is determined to be recorded into the recording area of the second layer, when recording of the remaining portion of the content data is ended or stopped;
an area reserving device for ensuring a reserved area to record therein management information of the second VTS, between a remaining area of the recording area of the first layer after the portion of the content data which forms the first VTS is recorded and a head area of the recording area of the second layer of the dual-layer recording disk; and
a management information recording device for recording the management information of the second VTS into the reserved area, said second content data recording device recording the content data from a position after the reserved area.

13. The recording apparatus according to claim 12, wherein
said area reserving device ensures a reserved area to record therein backup information about management information of the first VTS in addition to the management information of the second VTS,
said recording apparatus further comprises a backup information recording device for recording the backup information about the management information of the first VTS into the reserved area.

14. The recording apparatus according to claim 12, further comprising:
an encoding device for encoding unencoded data, which is the content data that has not been encoded yet, to thereby generate the content data,
the process of forming the first VTS by said first VTS formation processing device, ensuring of the reserved area by said area reserving device, and the recording of the remaining portion of the content data by said second content data recording device being performed while an encoding process is continued by said encoding device.

15. The recording apparatus according to claim 13, further comprising:
an encoding device for encoding unencoded data, which is the content data that has not been encoded yet, to thereby generate the content data,
the process of forming the first VTS by said first VTS formation processing device, ensuring of the reserved area by said area reserving device, and the recording of the remaining portion of the content data by said second content data recording device being performed while an encoding process is continued by said encoding device.

16. A recording apparatus for recording content data over two layers of a dual-layer recording disk, said recording apparatus comprising:
a first area reserving device for ensuring a first reserved area to record therein first management information for a first data block, in a recording area of a first layer of the dual-layer recording disk;
a first content data recording device for recording the content data from a position after the first reserved area in the recording area of the first layer;
a judging device for judging that the content data is recorded by said first content data recording device up to near a tail position of the recording area of the first layer;
a first data block formation processing device for performing a process for forming the first data block by using a portion of the content data which is recorded in the recording area of the first layer and a portion of the content data which is determined to be recorded into the recording area of the first layer, in accordance with a judgment result by said judging device;
a second area reserving device for ensuring a second reserved area to record therein second management information for a second data block, between a remaining area of the recording area of the first layer after a portion of the content data, which forms the first data block, is recorded and a head area of a recording area of a second layer of the dual-layer recording disk;
a second content data recording device for recording a remaining portion of the content data from a position after the second reserved area in the recording area of the second layer;
a second data block formation processing device for performing a process for forming the second data block by using a portion of the remaining portion of the content data which is recorded in the recording area of the second layer and a portion of the remaining portion of the content data which is determined to be recorded into the recording area of the second layer, when recording of the remaining portion of the content data is ended or stopped;
a first management information recording device for recording the first management information into the first reserved area; and
a second management information recording device for recording the second management information into the second reserved area.

17. The recording apparatus according to claim 16, further comprising:
an encoding device for encoding unencoded data, which is the content data that has not been encoded yet, to thereby generate the content data,
the process of forming the first data block by said first data block formation processing device, ensuring of the second reserved area by said second area reserving device, and the recording of the remaining portion of the content data by said second content data recording device being performed while an encoding process is continued by said encoding device.

18. A recording method of recording content data over two layers of a dual-layer recording disk, said recording method comprising:
a first content data recording process of recording the content data into a recording area of a first layer of the dual-layer recording disk;
a judging process of judging that the content data is recorded in said first content data recording process up to near a tail position of the recording area of the first layer;
a first VTS formation processing process of performing a process for forming first VTS by using a portion of the content data which is recorded in the recording area of the first layer and a portion of the content data which is determined to be recorded into the recording area of the first layer, in accordance with a judgment result in said judging process;
a second content data recording process of recording a remaining portion of the content data into a recording area of a second layer;
a second VTS formation processing process of performing a process for forming second VTS by using a portion of the remaining portion of the content data which is recorded in the recording area of the second layer and a portion of the remaining portion of the content data which is determined to be recorded into the recording area of the second layer, when recording of the remaining portion of the content data is ended or stopped;
an area reserving process of ensuring a reserved area to record therein management information of the second VTS, between a remaining area of the recording area of the first layer after the portion of the content data which forms the first VTS is recorded and a head area of the recording area of the second layer of the dual-layer recording disk; and
a management information recording process of recording the management information of the second VTS into the reserved area,
said second content data recording process recording the content data from a position after the reserved area.

19. A recording method of recording content data over two layers of a dual-layer recording disk, said recording method comprising:
a first area reserving process of ensuring a first reserved area to record therein first management information for a first data block, in a recording area of a first layer of the dual-layer recording disk;
a first content data recording process of recording the content data from a position after the first reserved area in the recording area of the first layer;
a judging d process of judging that the content data is recorded in said first content data recording process up to near a tail position of the recording area of the first layer;
a first data block formation processing process of performing a process for forming the first data block by using a portion of the content data which is recorded in the recording area of the first layer and a portion of the content data which is determined to be recorded into the recording area of the first layer, in accordance with a judgment result in said judging process;
a second area reserving process of ensuring a second reserved area to record therein second management information for a second data block, between a remaining area of the recording area of the first layer after a portion of the content data, which forms the first data block, is recorded and a head area of a recording area of a second layer of the dual-layer recording disk;
a second content data recording process of recording a remaining portion of the content data from a position after the second reserved area in the recording area of the second layer;
a second data block formation processing process of performing a process for forming the second data block by using a portion of the remaining portion of the content data which is recorded in the recording area of the second layer and a portion of the remaining portion of the content data which is determined to be recorded into the recording area of the second layer, when recording of the remaining portion of the content data is ended or stopped;
a first management information recording process of recording the first management information into the first reserved area; and
a second management information recording process of recording the second management information into the second reserved area.

20. A computer program product for making a computer function as a recording apparatus for recording content data over two layers of a dual-layer recording disk, said recording apparatus comprising:
a first content data recording device for recording the content data into a recording area of a first layer of the dual-layer recording disk;
a judging device for judging that the content data is recorded by said first content data recording device up to near a tail position of the recording area of the first layer;
a first VTS formation processing device for performing a process for forming first VTS by using a portion of the content data which is recorded in the recording area of the first layer and a portion of the content data which is determined to be recorded into the recording area of the first layer, in accordance with a judgment result by said judging device;
a second content data recording device for recording a remaining portion of the content data into a recording area of a second layer;
a second VTS formation processing device for performing a process for forming second VTS by using a portion of the remaining portion of the content data which is recorded in the recording area of the second layer and a portion of the remaining portion of the content data which is determined to be recorded into the recording area of the second layer, when recording of the remaining portion of the content data is ended or stopped;
an area reserving device for ensuring a reserved area to record therein management information of the second VTS, between a remaining area of the recording area of the first layer after the portion of the content data which forms the first VTS is recorded and a head area of the recording area of the second layer of the dual-layer recording disk; and
a management information recording device for recording the management information of the second VTS into the reserved area,
said second content data recording device recording the content data from a position after the reserved area.

21. A computer program product for making a computer function as a recording apparatus for recording content data over two layers of a dual-layer recording disk, said recording apparatus comprising:
a first area reserving device for ensuring a first reserved area to record therein first management information for a first data block, in a recording area of a first layer of the dual-layer recording disk;
a first content data recording device for recording the content data from a position after the first reserved area in the recording area of the first layer;
a judging device for judging that the content data is recorded by said first content data recording device up to near a tail position of the recording area of the first layer;
a first data block formation processing device for performing a process for forming the first data block by using a portion of the content data which is recorded in the recording area of the first layer and a portion of the content data which is determined to be recorded into the recording area of the first layer, in accordance with a judgment result by said judging device;
a second area reserving device for ensuring a second reserved area to record therein second management information for a second data block, between a remaining area of the recording area of the first layer after a portion of the content data, which forms the first data block, is recorded and a head area of a recording area of a second layer of the dual-layer recording disk;
a second content data recording device for recording a remaining portion of the content data from a position after the second reserved area in the recording area of the second layer;
a second data block formation processing device for performing a process for forming the second data block by using a portion of the remaining portion of the content data which is recorded in the recording area of the second layer and a portion of the remaining portion of the content data which is determined to be recorded into the recording area of the second layer, when recording of the remaining portion of the content data is ended or stopped;
a first management information recording device for recording the first management information into the first reserved area; and
a second management information recording device for recording the second management information into the second reserved area.
